(19) United States
(12) Patent Application Publication
(10) Pub. No.: US 2024/0059272 A1
(43) Pub. Date: Feb. 22, 2024

(54) HYBRID ELECTRIC VEHICLE AND METHOD OF SUPPORTING SOUND INPUT AND OUTPUT FOR THE SAME

(71) Applicants: Hyundai Motor Company, Seoul (KR); Kia Corporation, Seoul (KR)

(72) Inventors: Jin Kyeom CHO, Suwon-si (KR); Sang Hun JUNG, Suncheon-si (KR); Joon Young PARK, Seoul (KR); Sung Deok KIM, Seongnam-si (KR)

(73) Assignees: Hyundai Motor Company, Seoul (KR); Kia Corporation, Seoul (KR)

(21) Appl. No.: 18/098,892

(22) Filed: Jan. 19, 2023

(30) Foreign Application Priority Data
Aug. 22, 2022 (KR) 10-2022-0105006

(51) Int. Cl. B60W 20/17; G10L 15/20; G10L 15/22; G10L 25/51

(52) U.S. Cl. CPC B60W 20/17; G10L 15/20; G10L 15/22; G10L 25/51; B60W 2540/21; B60W 2510/244; B60W 2510/305; B60W 2510/0638; B60W 2420/54; G10L 2015/223

(57) ABSTRACT

A hybrid electric vehicle (HEV) and a method of supporting sound input and output for the same, the method comprising: determining whether a first condition for a sound input and output function and a second condition for an internal noise level are satisfied; determining whether operation termination of an engine is possible when the first condition and the second condition are satisfied; controlling the HEV to be driven in a first mode when the operation termination of the engine is impossible; and performing noise reduction control by changing an operating point of the engine.

### CROSS REFERENCE TO RELATED APPLICATION

The present application claims priority to Korean Patent Application No. 10-2022-0105006, filed on Aug. 22, 2022 in the Korean Intellectual Property Office, the entire contents of which is incorporated herein for all purposes by this reference.

### TECHNICAL FIELD

The disclosure relates to a hybrid electric vehicle and a method of supporting a sound input and output for the same, in which the noise of a powertrain is controlled to improve a recognition rate of a voice command input and allow a driver to easily recognize a sound guide output.

### BACKGROUND

Recently, a voice-based input and output function has been actively applied to a vehicle. For example, a driver may input a voice for a destination to a navigation system, and a turn-by-turn guide may be output as a voice during route guidance. However, the vehicle is in an environment where noise is continuously generated by a powertrain when driving, and ambient noise as well as road noise is introduced into the interior. Therefore, when the voice input and output function is used in the vehicle's interior, there are problems in that the noise may lower the recognition rate for a driver's voice and make it difficult for the driver to recognize a voice guide output from the vehicle. In particular, a voice-based command input is generally more effective in preventing a driver from being distracted than a physical control-based command input, but a low voice recognition rate causes a problem because it distracts a driver while the driver repeatedly inputs a voice command and checks a recognition result.

Meanwhile, eco-friendly vehicles using an electric motor as a power source are increasing as interest in the environment has recently increased. The eco-friendly vehicle is also called an electrified vehicle, and an electric vehicle (EV) and a hybrid electric vehicle (HEV) are representative examples of the eco-friendly vehicle. However, even the HEV is not completely free from noise problems because engine sound is introduced into the interior while an engine is running, and the electric motor is only relatively quiet compared to the engine while only the electric motor is running.

Accordingly, even an HEV involves the powertrain and the like factors that disrupt a voice input and output as described above, and it is, therefore, necessary to propose a method of solving such disruptive factors.

### SUMMARY DISCLOSURE

An aspect of the disclosure is to provide a hybrid electric vehicle (HEV), which can effectively control noise when using a function related to a voice input and output, and a method of supporting a sound input and output for the same.

Technical problems to be solved in the disclosure are not limited to the aforementioned technical problems, and other unmentioned technical problems can be clearly understood from the following description by a person having ordinary knowledge in the art to which the disclosure pertains.

According to an embodiment of the disclosure, a method of supporting sound input and output in an HEV includes: determining whether a first condition for a sound input and output function and a second condition for an internal noise level are satisfied; determining whether operation termination of an engine is possible when the first condition and the second condition are satisfied; controlling the HEV to be driven in a first mode, in which a starter/generator motor charges a battery with the power of the engine in response to determination that the operation termination of the engine is impossible; and performing noise reduction control by changing an operating point of the engine during the first mode.

For example, the first condition is satisfied when an output of a sound guide is scheduled, an input of a voice command is started, or the output of the sound guide is scheduled and the input of the voice command is started.

For example, the second condition is satisfied when the internal noise level is greater than a preset reference noise level.

For example, the determining whether the operation termination of the engine is possible may include determining whether the operation termination of the engine is possible based on one of a state of charge (SOC) of the battery, whether an air conditioning request is generated, whether the motor discharge is restricted, and a combination thereof.

For example, the method may further include controlling the HEV to be driven in a second mode, in which the vehicle drives without operating the engine, in response to determination that the operation termination of the engine is possible.

For example, the performing the noise reduction control may include changing a current operating point of the engine to an operating point having a lower noise level.

For example, the changing to an operating point having a lower noise level may be performed by referring to a noise level map for torque and revolution per minute (RPM) of the engine.

For example, the method may further include: determining whether one of a sound guide, a voice command and a combination thereof is likely to be additionally generated; and terminating the noise reduction control at a preset point in time, in response to determination that the one of a sound guide, a voice command and a combination thereof is unlikely to be additionally generated.

For example, the determining whether the one of a sound guide, a voice command and a combination thereof is likely to be additionally generated may include determining whether the one of a sound guide, a voice command and a combination thereof is likely to be additionally generated, based on one of content of the sound guide, content of the voice command and a combination thereof.

For example, the method may further include: checking a target driving mode; and changing a current operating point of the engine to an operating point having RPM corresponding to motor RPM, when the target driving mode is a third mode where the power of the engine is transmitted to wheels, and the one of a sound guide, a voice command and a combination thereof is unlikely to be additionally generated.

According to an embodiment of the disclosure, an HEV includes: an engine; a motor; and a control unit configured to determine whether a first condition for a sound input and output function and a second condition for an internal noise level are satisfied, determine whether operation termination of an engine is possible when the first condition and the second condition are satisfied, control the HEV to be driven in a first mode, in which a starter/generator motor charges a battery with power of the engine, in response to determination that the operation termination of the engine is impossible, and perform noise reduction control by changing an operating point of the engine during the first mode.

For example, the first condition is satisfied when an output of a sound guide is scheduled, an input of a voice command is started, or the output of the sound guide is scheduled and the input of the voice command is started.

For example, the second condition is satisfied when the internal noise level is greater than a preset reference noise level.

For example, the control unit may be configured to determine whether the operation termination of the engine is possible based on one of an SOC of the battery, whether an air conditioning request is generated, whether the motor discharge is restricted and a combination thereof.

For example, the control unit may be configured to control the HEV to be driven in a second mode, in which the vehicle drives without operating the engine, in response to determination that the operation termination of the engine is possible.

For example, the control unit may be configured to perform the noise reduction control by changing a current operating point of the engine to an operating point having a lower noise level.

For example, the control unit may be configured to perform change to an operating point having a lower noise level by referring to a noise level map for the torque and RPM of the engine.

For example, the control unit may be configured to: determine whether one of a sound guide, a voice command and a combination thereof is likely to be additionally generated; and terminate the noise reduction control at a preset point in time, in response to determination that the one of a sound guide, a voice command and a combination thereof is unlikely to be additionally generated.

For example, the control unit may be configured to determine whether the one of a sound guide, a voice command and a combination thereof is likely to be additionally generated, based on one of the content of the sound guide, the content of the voice command and a combination thereof.

For example, the control unit may be configured to check a target driving mode, and change a current operating point of the engine to an operating point having RPM corresponding to motor RPM, when the target driving mode is a third mode where the power of the engine is transmitted to wheels, and the one of a sound guide, a voice command and a combination thereof is unlikely to be additionally generated.

Problems according to the disclosure may not be limited by the aforementioned problems, and other unmentioned problems can be clearly understood from the following description by those skilled in the art.

As described above, according to various embodiments of the disclosure, when a sound input and output function is used in an HEV, noise generated in the vehicle is reduced through powertrain control, so that the vehicle can be improved in a recognition rate for voice command and a driver can easily recognize a voice guide output from the vehicle.

Effects obtainable from the disclosure may not be limited by the aforementioned effects, and other unmentioned effects can be clearly understood from the following description by a person having ordinary knowledge in the art to which the disclosure pertains

### BRIEF DESCRIPTION OF THE DRAWINGS

FIG. 1 is a diagram showing an example of a powertrain structure in a hybrid electric vehicle (HEV) applicable to embodiments of the disclosure.

FIG. 2 is a block diagram showing an example of a control system in an HEV to which embodiments of the disclosure are applicable.

FIG. 3 is a diagram showing an example of a control unit supporting a sound input and output according to an embodiment of the disclosure.

FIG. 4 is a view for explaining determination of whether a voice command or a sound guide is likely to be additionally generated based on the content of the voice command, according to an embodiment of the disclosure.

FIG. 5 is a view for explaining determination of whether a voice command or a sound guide is likely to be additionally generated based on the content of the sound guide, according to an embodiment of the disclosure.

FIG. 6 is a view for explaining an operating point change for noise reduction according to embodiments of the disclosure.

FIG. 7 is a view for explaining an operating point change for rapid acceleration according to embodiments of the disclosure.

FIG. 8 is a flowchart showing a sound input and output support method in an HEV according to an embodiment of the disclosure

FIG. 9 is a flowchart for explaining a sound input and output support method in detail in an HEV according to an embodiment of the disclosure.

### DETAILED DESCRIPTION

Hereinafter, embodiments of the disclosure will be described in detail with reference to the accompanying drawings, in which the same or similar elements are denoted by the same reference numerals even though they are depicted in different drawings and redundant descriptions thereof will be avoided. Suffixes “module” and “unit” put after elements in the following description are given in consideration of only ease of description and do not have meaning or functions discriminated from each other. In terms of describing the embodiments of the disclosure, detailed descriptions of related art will be omitted when they may make the subject matter of the embodiments of the disclosure rather unclear. In addition, the accompanying drawings are provided only for a better understanding of the embodiments of the disclosure and are not intended to limit technical ideas of the disclosure. Therefore, it should be understood that the accompanying drawings include all modifications, equivalents and substitutions within the scope and sprit of the disclosure.

Terms such as “first” and “second” may be used to describe various components, but the components should not be limited by the above terms. In addition, the above terms are used only for the purpose of distinguishing one component from another.

When it is described that one component is “connected” or “joined” to another component, it should be understood that the one component may be directly connected or joined to another component, but additional components may be present therebetween. However, when one component is described as being “directly connected,” or “directly coupled” to another component, it should be understood that additional components may be absent between the one component and another component.

Unless the context clearly dictates otherwise, singular forms include plural forms as well.

In the disclosure, it should be understood that term “include” or “have” indicates that a feature, a number, a step, an operation, an element, a part, or the combination thereof described in the embodiments is present, but does not preclude a possibility of presence or addition of one or more other features, numbers, steps, operations, elements, parts or combinations thereof, in advance.

Prior to describing a hybrid electric vehicle (HEV) and a method of supporting a sound input and output for the same according to embodiments of the disclosure, the structure and control system of an HEV applicable to the embodiments will be first described by way of example.

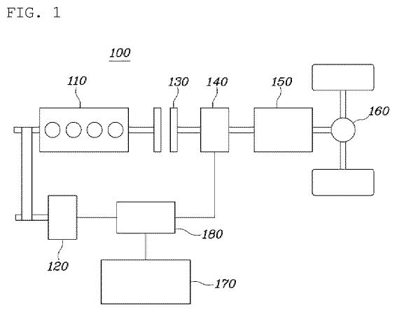

FIG. 1 shows an example of a powertrain structure of an HEV applicable to the embodiments of the disclosure.

Referring to FIG. 1, a powertrain of an HEV is illustrated with a parallel type hybrid system in which an electric motor (or a driving motor) 140 and an engine clutch 130 are mounted between an internal combustion engine (ICE) 110 and a transmission 150.

In such a vehicle, generally, when a driver steps on an accelerator (or when a gas pedal sensor is turned on) after starting, the motor 140 is first driven using the power of a battery while the engine clutch 130 is open, and the power of the motor is transmitted via the transmission 150 and a final drive (FD) 160, thereby moving wheels (i.e., electric vehicle (EV) mode). When the vehicle is gradually accelerated requiring a stronger driving power, an auxiliary motor (or a starter/generator motor) 120 may operate to drive an engine 110.

When difference in rotational speed between the engine 110 and the motor 140 falls within a certain range, the engine clutch 130 is engaged and then both the engine 110 and the motor 140 together drive the vehicle (i.e., transition from the EV mode to an HEV mode). When a preset engine-off condition is satisfied due to deceleration or the like of the vehicle, the engine clutch 130 is opened and the engine 110 stops (i.e., transition from the HEV mode to the EV mode). At this time, the vehicle charges a battery 170 through the motor 140 based on the driving force of the wheels, which is called braking energy regeneration or regenerative braking. Therefore, the starter/generator motor 120 may be called a hybrid starter generator (HSG) because it serves as a start motor when the engine 110 starts, and operates as a generator after starting or while recovering the rotational energy of the engine 110 as the engine 110 stops.

In general, the transmission 150 may employ a discrete variable transmission or a multi-plate clutch, for example, a dual clutch transmission (DCT).

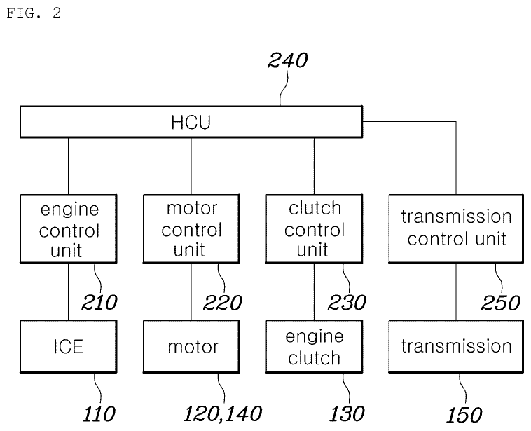

FIG. 2 is a block diagram showing an example of a control system in an HEV to which embodiments of the disclosure are applicable.

Referring to FIG. 2, in the HEV according to embodiments of the disclosure, the internal combustion engine 110 may be controlled by the engine control unit 210, the torques of the starter/generator motor 120 and the driving motor 140 may be controlled by the motor control unit (MCU) 220, and the engine clutch 130 may be controlled by a clutch control unit 230. Here, the engine control unit 210 may also be called an engine management system (EMS). Further, the transmission 150 is controlled by a transmission control unit 250.

Each control unit is connected to its upper level control unit, i.e., a hybrid control unit (HCU) 240 that controls an overall mode switching process, and provides information needed for controlling the engine clutch 130 when changing a driving mode or shifting gears and/or information needed for controlling the engine 110 to stop to the hybrid control unit 240 or operates in response to a control signal under control of the hybrid control unit 240.

For example, the hybrid control unit 240 determines whether to perform switching between EV-HEV modes or between CD-CS modes according to the driving states of the vehicle. To this end, the hybrid control unit determines a point in time when the engine clutch 130 is opened, and performs hydraulic control when the engine clutch 130 is opened. Further, the hybrid control unit 240 determines the states (e.g., lock-up, slip, open, etc.) of the engine clutch 130, and controls a point in time when fuel injection for the engine 110 is stopped. Further, the hybrid control unit may control the rotational energy of the engine 110 to be recovered by transmitting a torque command to the motor control unit 220 to control the torque of the starter/generator motor 120 in order to control the engine 110 to stop. In addition, the hybrid control unit 240 can control a lower level control unit to determine a mode switching condition and switch the mode during droving mode switching control.

Of course, it will be apparent to those skilled in the art that the foregoing connection between the control units and the foregoing function/division of each control unit are merely examples and there are no limits to their names. For example, the hybrid control unit 240 may be replaced by any one of the other control units, or its function may be provided as distributed to two or more of the other control units.

The terms “unit” or “control unit” forming part of the names of the motor control unit (MCU), the hybrid control unit (HCU), etc., are merely terms that are widely used in the naming of a controller for controlling a specific function of a vehicle, and should not be construed as meaning a generic function unit. For example, each control unit may include a communication device that communicates with other control units or sensors, in order to control its own functions, a memory that stores an operating system, logic commands, and input and output information, and one or more processors that perform determination, calculation, decision, and the like, which is necessary for the control of the function that is responsible therefor. According to an exemplary embodiment of the present disclosure, the control unit may include a processor (e.g., computer, microprocessor, CPU, ASIC, circuitry, logic circuits, etc.) and an associated non-transitory memory storing software instructions which, when executed by the processor, provides the functionalities of the engine control unit 210, the motor control unit (MCU) 220, the clutch control unit 230 and the hybrid control unit (HCU) 240. Herein, the memory and the processor may be implemented as separate semiconductor circuits. Alternatively, the memory and the processor may be implemented as a single integrated semiconductor circuit. The processor may embody one or more processor(s).

It will be apparent to those skilled in the art that the foregoing configurations shown in FIGS. 1 and 2 are merely examples of the configuration of the HEV, and the HEV applicable to the embodiments is not limited to this structure.

According to an embodiment of the disclosure, if the operation of the engine 110 cannot be stopped when the HEV receives a voice command or outputs a sound guide, the power of the engine 110 makes the starter/generator motor 120 run in a mode for charging the battery 170, and noise reduction control is performed by changing an operating point of the engine 110. In this way, it is proposed that noise generated by the powertrain is reduced through operating point control so as to increase a voice recognition rate and allow an occupant to well recognize a guide sound output from the vehicle.

Here, the operating point may refer to each torque and RPM of driving sources, such as the driving motor 140 and the engine 110, which currently operates according to driving modes. In particular, an engine operating point refers to the torque and RPM of the engine 110. For example, when the current driving mode is the HEV mode, the operating point is moved to an operating point with relatively less noise than the current operating point of the engine 110, thereby reducing powertrain noise. Further, by a load leveling method without sacrificing driving performance, the torque of the engine 110, of which noise is relatively loud compared to the driving motor 140, is first reduced, and then the torque of the driving motor 140 is increased as much, thereby generally reducing the noise of the powertrain.

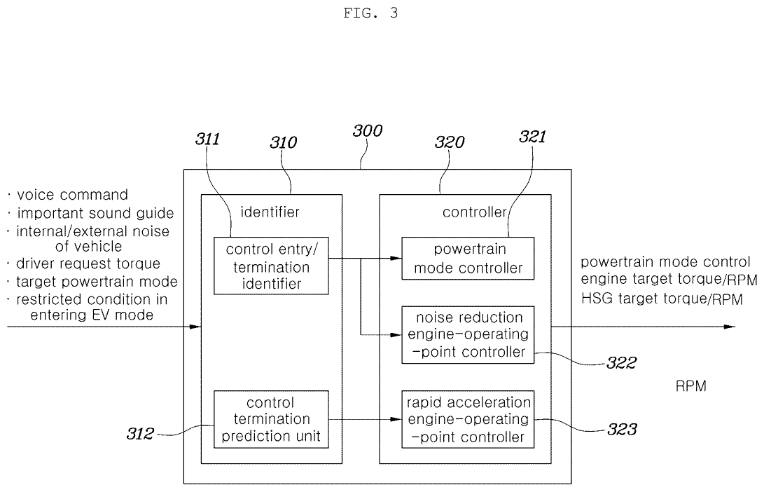

First, a sound input and output support control unit, which can perform powertrain control to effectively support the sound input and output, according to an embodiment will be described with reference to FIG. 3.

FIG. 3 is a diagram showing an example of a sound input and output support control unit according to an embodiment of the disclosure.

Referring to FIG. 3, a sound input and output support control unit 300 according to an embodiment may have input information about a voice command, an important sound guide, the internal and external noise of a vehicle, a driver request torque (or request power), a target powertrain mode (or a driving mode), a restricted condition in entering an EV mode, etc. Further, the sound input and output support control unit 300 may have output information about powertrain mode control, the target torque and RPM of the engine, the target torque and RPM of the starter/generator motor 120, etc.

Here, the sound guide may include information in the form of voice like a navigation guide voice information, but is not limited thereto. For example, a warning sound other than the voice may be included in the sound guide. Of course, the sound guide, which satisfies a condition for entering the noise reduction control of the powertrain according to an embodiment, may include all kinds of sound guide output through a loudspeaker, or may restrictively include preset kinds of sound guide (e.g., turn-by-turn guide voice, a speed camera warning sound, etc.) in order to prevent disruption to drivability or decrease in fuel efficiency due to frequent powertrain control.

Further, information indicating whether the output of the sound guide such as a voice command or an important sound guide starts or ends may be provided by an audio/video/navigation (AVN) system, but is not limited thereto and may vary depending on the sources of the sound guide.

The source of information indicating whether the input of the voice command starts or ends may also be similar to the source of the information indicating whether the output of the sound guide starts or ends. For example, when the AVN system activates a voice recognition function as a driver controls a voice recognition button on a steering wheel to input a voice command, the start of the voice command input may be transmitted to the sound input and output support control unit 300. Further, when the AVN system determines whether the recognition of the voice command succeeds or fails, or when a driver terminates the voice recognition function, the AVN system may notify the sound input and output support control unit 300 of the end of the voice command input. Of course, this is merely an example, but not limited thereto.

The information about the internal noise of the vehicle may be provided through a microphone inside the vehicle, or may refer to information such as a lookup table previously prepared according to the current operating point and shift stage of the powertrain.

The driver request torque may be obtained from a upper level control unit for controlling the powertrain, e.g., the hybrid control unit 240.

Meanwhile, as output information, information about a target shift stage may be transmitted to the transmission control unit 250, a load level ratio may be transmitted in the form of an engine torque command and a motor torque command to the engine control unit 210 and the motor control unit 220, respectively. Further, an output torque change limit per hour may be transmitted to each of the engine control unit 210 and the motor control unit 220, or may be previously applied to the engine torque command and the motor torque command to be transmitted to each of the engine control unit 210 and the motor control unit 220 instead of separate information/command.

The sound input and output support control unit 300 may be efficiently implemented as a function of the upper level control unit for controlling an overall powertrain such as the hybrid control unit 240 (i.e., the vehicle control unit (VCU) in the case of electric vehicles) because it involves control of the powertrain (e.g., control of the operating point), but this is merely an example and not limited thereto.

Below, the sound input and output support control unit 300 will be described in detail.

The sound input and output support control unit 300 may include an identifier 310, and a controller 320. The identifier 310 may include a control entry/termination identifier 311, and a control termination prediction unit 312. The controller 320 may include a powertrain mode controller 321, a noise reduction engine-operating-point controller 322, and a rapid acceleration engine-operating-point controller 323.

First, the control entry/termination identifier 311 of the identifier 310 may determine whether to enter or terminate the noise reduction control of the powertrain so as to support the sound input and output according to an embodiment based on the foregoing input information.

For example, the control entry/termination identifier 311 may determine whether a preset entry condition is satisfied or not. For example, the entry condition may be satisfied i) when a preset kinds of sound guide is predicted or started or a driver activates the voice recognition function or inputs the voice command, and ii) when the internal noise of the vehicle is greater than reference noise. Here, the reference noise may be set in advance as a noise level, at which the voice recognition rate is lowered below a certain level, through a test, but is not limited thereto. By determining whether the foregoing entry condition is satisfied, and performing the noise reduction control when the entry condition is satisfied, it is possible to prevent a driver's voice command from being incorrectly recognized due to noise or a driver from incorrectly hearing the sound guide due to noise. Further, the control entry/termination identifier 311 may determine whether the operation termination of the engine 110 is possible, and may also transmit a mode switching requestor or a mode keeping request to the controller 320 according to determination results. For example, when it is determined that the operation termination of the engine 110 is impossible, the driving mode may be switched over to or keep a first mode where the starter/generator motor 120 charges the battery 170 with the power of the engine 110 like an HEV-series mode. When it is determined that the operation termination of the engine 110 is possible, the driving mode may be switched over to or keep a second mode where the vehicle is driven without operating the engine like an EV mode. In this way, the noise reduction method is determined when entering the noise reduction control. For example, when the operation termination of the engine 110 is possible, noise is reduced by terminating the operation of the engine 110 like the EV mode. When the operation termination of the engine 110 is impossible, noise is reduced by separately controlling the operating point.

In this case, whether the operation termination of the engine 110 is possible may be determined based on at least one among the state of charge (SOC) of the battery 170, whether an air conditioning request is generated, or whether motor discharge is restricted. Here, the air conditioning request may include heating control unit's request for operating the engine, and whether the motor discharge is restricted may be determined based on the temperature, states of charge/discharge, etc. of a battery.

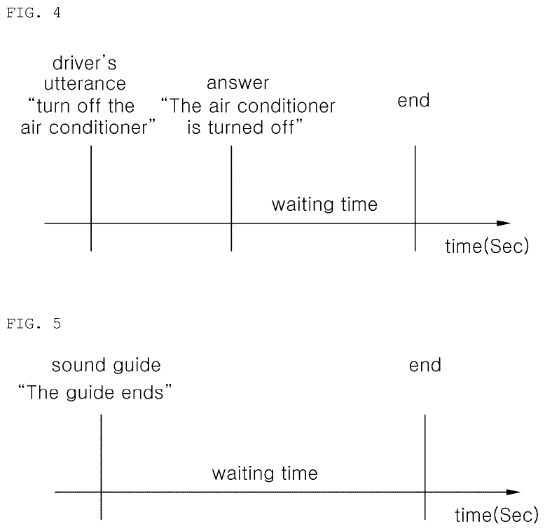

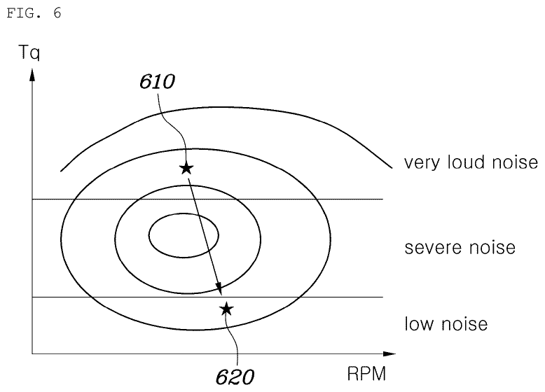

Meanwhile, the control termination prediction unit 312 may determine whether at least one of the sound guide and the voice command is likely to be additionally generated. When it is determined that at least one of the sound guide and the voice command is not likely to be additionally generated, the control termination prediction unit 312 may make a request for terminating the noise reduction control at a preset point in time to the controller 320. To determine whether at least one of the sound guide and the voice command is likely to be additionally generated, the content of the sound guide and the content of the voice command may be taken into account. In this regard, detailed descriptions will be made later with reference to FIGS. 4 and 5.

Next, the elements of the controller 320 will be described.

The powertrain mode controller 321 may control the powertrain as requested, thereby switching over to or keeping the powertrain mode or the driving mode, such as the EV mode, the HEV-series mode, and the HEV-parallel mode.

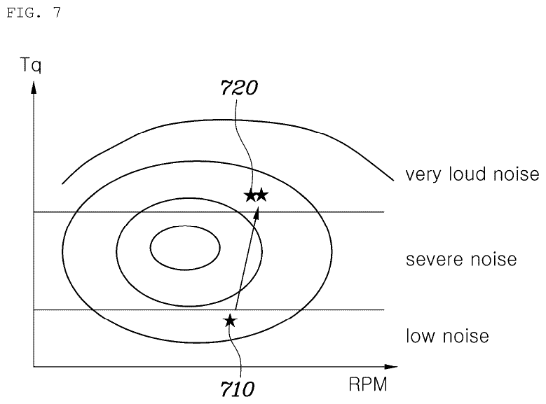

Meanwhile, the noise reduction engine-operating-point controller 322 performs overall noise reduction control by moving the operating point of the engine 110 to the operating point corresponding to relatively less noise. To this end, a noise map for each operating point may be used. Further, based on the load leveling control, the relatively loud noise of the engine 110 is reduced in such a manner that the torque of the engine 110 is decreased and the torque of the driving motor 140 is increased to compensate for the decreased engine torque, thereby performing control to reduce the overall powertrain noise. Detailed descriptions of the noise reduction control based on the noise map for each operating point will be described later with reference to FIG. 6.

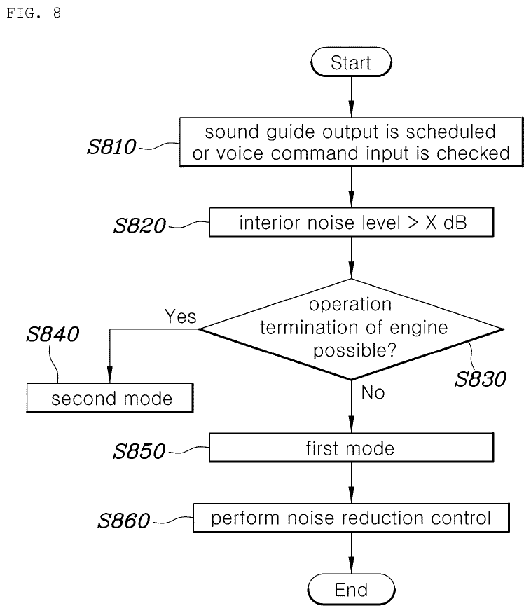

Meanwhile, the rapid acceleration engine-operating-point controller 323 may check a target driving mode based on input information when the noise reduction control is terminated as requested, and control the current operating point of the engine 110 to move to the operating point having the RPM corresponding to the RPM of the motor 140 when the checked target driving mode is a third mode where the power of the engine is transmitted to the wheels like the HEV-parallel mode. In this regard, detailed descriptions will be made later with reference to FIG. 7.

Below, the operations performed by the configurations described with reference to FIG. 3 will be described with reference to FIGS. 4 to 7.

FIG. 4 is a view for explaining determination of whether the voice command or the sound guide is likely to be additionally generated based on the content of the voice command, according to an embodiment of the disclosure.

Referring to FIG. 4, an determination process according to an embodiment may include a driver's utterance, answering, waiting, and ending in sequence, and the content of the voice command corresponding to a driver's utterance may be used to determine whether the voice command or the sound guide is likely to be additionally generated. For example, a driver's utterance includes the content of “turn off the air conditioner,” as shown in FIG. 4, or content that is unlikely to be followed by additional voice control, such as “terminate the guidance,” “open the sunroof,” and “turn off the air conditioner,” it may be determined that the voice command and the sound guide will not be additionally generated after answering the utterance. In this case, the noise reduction control may be maintained during a waiting time, and the noise reduction control may be terminated at a point in time when the waiting time is over. On the other hand, a driver's utterance includes content that needs to be followed by additional control, such as “set the air conditioning temperature to 23 degrees,” “turn on the air conditioner,” “open the sunroof,” and “start route guidance,” it may be determined that the voice command and the sound guide will be additionally generated.

Meanwhile, such determination may be performed by taking the content of the sound guide into account, which will be described below with reference to FIG. 5.

FIG. 5 is a view for explaining determination of whether the voice command or the sound guide is likely to be additionally generated based on the content of the sound guide, according to an embodiment of the disclosure.

Referring to FIG. 5, the guide content and the waiting time may be used to determine whether the voice command or the sound guide is likely to be additionally generated. For example, the sound guide includes content such as “the guide ends” and “Please tell me if you want additional guide,” it may be determined that the voice command and the sound guide will not be additionally generated when the waiting time elapses after the sound guide. In this case, the noise reduction control is maintained during the waiting time. When the voice command is generated within the waiting time, the noise reduction control is not terminated even when the waiting time has elapsed.

FIGS. 4 and 5 illustrate the operations of determining whether to terminate the noise reduction control and when the noise reduction control is terminated, according to embodiments of the disclosure. Below, the operating point control according to the embodiments will be described with reference to FIGS. 6 and 7.

Referring to FIGS. 6 and 7, the horizontal axis of the graph indicates the RPM of the engine 110, and the vertical axis indicates the torque of the engine 110. On the assumption that the noise level is highly dependent on the torque, each graph is divided into three areas of very loud, severe and low noise for each engine operating point. Further, a curve in each graph indicates an equal power line that joins the points of equal power. Such a noise map may be obtained based on a type of engine 110 and a vehicle test.

FIG. 6 is a view for explaining an operating point change for noise reduction according to embodiments of the disclosure.

Referring to FIG. 6, a current engine operating point 610 is located in an area corresponding to very loud noise, and thus the noise reduction engine-operating-point controller 322 makes a decision to change to an operating point 620 in an area corresponding to low noise, where noise is less than that of the current operating point 610. The noise reduction engine-operating-point controller 322 may move the operating point by controlling the speed of the connected engine 110 through the speed control of the starter/generator motor 120 while the vehicle is driven in the first mode. In this way, noise is reduced even when the operation termination of the engine 110 is impossible.

FIG. 7 is a view for explaining an operating point change for rapid acceleration according to embodiments of the disclosure.

Referring to FIG. 7, a current engine the operating point 710 is located in an area corresponding to low noise, and thus the rapid acceleration engine-operating-point controller 323 performs the operating point control for the rapid acceleration when the target driving mode is the third mode where the power of the engine is transmitted to the wheels like the HEV-parallel mode after terminating the noise reduction control. Therefore, the rapid acceleration engine-operating-point controller 323 may change the current operating point 710 into an operating point 720 having the RPM corresponding to the RPM of the motor 140. Even in the case of such rapid acceleration operating point control, the operating point may be moved by controlling the speed of the connected engine 110 through the speed control of the starter/generator motor 120. In this way, the time of engaging the engine 110 and clutch 130 is shortened when the driving mode is returned or switched after the noise reduction control is terminated.

The operations described above are summarized in a flowchart as shown in FIG. 8.

FIG. 8 is a flowchart showing a sound input and output support method in the HEV according to an embodiment of the disclosure.

Referring to FIG. 8, when the sound guide output is scheduled or the voice command input is checked (S810), and when the interior noise level is greater than a preset reference noise (S820), the vehicle enters the noise reduction control.

Then, when the operation termination of the engine 110 is possible (YES in S830), the vehicle is driven in the second mode, in which the vehicle drives without operating the engine 110 (S840). On the other hand, when the operation termination of the engine 110 is impossible (NO in S830), the vehicle is driven in the first mode where the starter/generator motor 120 charges the battery 170 with the power of the engine 110. In the case of the first mode, control for reducing the noise due to the operation of the engine 110 is performed (S860).

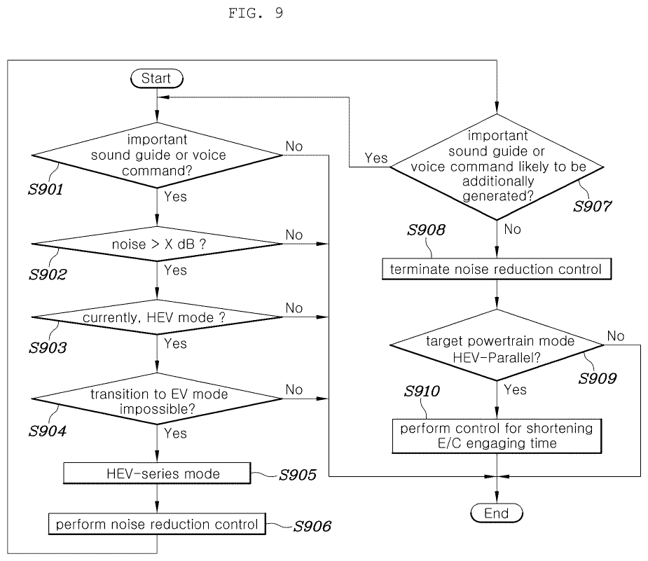

Below, the sound input and output support method according to an embodiment of the disclosure will be described in more detail with reference to FIG. 9.

FIG. 9 is a flowchart for explaining the sound input and output support method in detail in the HEV according to an embodiment of the disclosure.

Referring to FIG. 9, the operations performed by the identifier 310 and the controller 320 of the control unit 300 will be described.

First, the entry/termination identifier 311 determines a first condition for the sound input and output function (S901). When the first condition is satisfied according to the schedule or start of the important sound guide, the input of the voice command, etc., it is determined whether a second condition for an internal noise level is satisfied (S902). When both the first condition and the second condition are satisfied, the entry/termination identifier 311 may make a request for entering the noise reduction control to the controller 320.

When the current driving mode of the vehicle is the HEV mode of operating the engine 110 (S903), the entry/termination identifier 311 first determines whether the operation termination of the engine 110 is possible, which involves whether the transition to the EV mode is possible, in order to reduce noise due to the operation of the engine 110 (S904). When the operation termination of the engine 110 is possible and the transition to the EV mode is possible (NO in S904), noise is reduced by terminating the operation of the engine 110, such as switching the driving mode over to the EV mode. On the other hand, when the operation termination of the engine 110 is impossible and the transition to the EV mode is impossible (YES in S904), the operation of the engine 110 is maintained, and the vehicle is driven in the first mode such as the HEV-series mode where the starter/generator motor 120 charges the battery 170 with the power of the engine 110 (S905).

When the vehicle is driven in the first mode such as the HEV-parallel mode, the noise reduction engine-operating-point controller 322 performs speed control for the starter/generator motor 120 and changes the current operating point of the engine 110 to the operating point where the noise level is relatively low in order to reduce the noise due to the operation of the engine 110 (S906).

During the operation S906, the control termination prediction unit 312 may determine whether the sound guide or the voice command is likely to be additionally generated (S907). When it is determined that the sound guide or the voice command is likely to be additionally generated (YES in S907), it may be determined again whether to perform the noise reduction control (S901)

When it is determined that the sound guide or the voice command is unlikely to be additionally generated (NO in S907), the noise reduction control may be terminated, and the target driving mode may be determined along with the termination of the noise reduction control (S909). When the target driving mode is the third mode such as the HEV-parallel mode (YES in S909), the rapid acceleration engine-operating-point controller 323 may change the engine operating point to the operating point having the RPM corresponding to the RPM of the motor 140 through the speed control of the starter/generator motor 120 in order to shorten the time of engaging the engine 110 and clutch 130 while switching the driving mode (S910). On the other hand, when the target driving mode is not the third mode (NO in S909), the control for shortening the time of engaging the engine 110 and clutch 130 may not be performed, and the engine operating point may be determined in consideration of whether the torque requested by a driver is satisfied according to preset default setting, and the states of the powertrain.

As described above, according to various embodiments of the disclosure, when a sound input and output function is used in an HEV, noise generated in the vehicle is reduced through powertrain control, so that the vehicle can be improved in a recognition rate for a voice command and a driver can easily recognize a voice guide output from the vehicle.

Effects obtainable from the disclosure may not be limited by the aforementioned effects, and other unmentioned effects can be clearly understood from the following description by a person having ordinary knowledge in the art to which the disclosure pertains.

What is claimed is:

1. A method of supporting sound input and output in a hybrid electric vehicle (HEV), the method comprising:
determining whether a first condition for a sound input and output function and a second condition for an internal noise level are satisfied;
determining whether operation termination of an engine is possible when the first condition and the second condition are satisfied;
controlling the HEV to be driven in a first mode, in which a starter/generator motor charges a battery with power of the engine, in response to determination that the operation termination of the engine is impossible; and
performing noise reduction control by changing an operating point of the engine during the first mode.

2. The method of claim 1, wherein the first condition is satisfied when an output of a sound guide is scheduled, an input of a voice command is started, or the output of the sound guide is scheduled and the input of the voice command is started.

3. The method of claim 1, wherein the second condition is satisfied when the internal noise level is greater than a preset reference noise level.

4. The method of claim 1, wherein the determining whether the operation termination of the engine is possible comprises: determining whether the operation termination of the engine is possible based on one of a state of charge (SOC) of the battery, whether an air conditioning request is generated, whether motor discharge is restricted and a combination thereof.

5. The method of claim 1, further comprising: controlling the HEV to be driven in a second mode, in which the vehicle drives without operating the engine, in response to determination that the operation termination of the engine is possible.

6. The method of claim 1, wherein the performing the noise reduction control comprises: changing a current operating point of the engine to an operating point having a lower noise level.

7. The method of claim 6, wherein changing a current operating point of the engine to an operating point having a lower noise level comprises:
referring to a noise level map for torque and revolution per minute (RPM) of the engine.

8. The method of claim 1, further comprising:
determining whether one of a sound guide, a voice command and a combination thereof is likely to be additionally generated; and
terminating the noise reduction control at a preset point in time, in response to determination that the one of a sound guide, a voice command and a combination thereof is unlikely to be additionally generated.

9. The method of claim 8, wherein the determining whether the one of a sound guide, a voice command and a combination thereof is likely to be additionally generated comprises:
determining whether the one of a sound guide, a voice command and a combination thereof is likely to be additionally generated, based on one of content of the sound guide, content of the voice command and a combination thereof.

10. The method of claim 8, further comprising:
checking a target driving mode; and
changing a current operating point of the engine to an operating point having RPM corresponding to motor RPM, when the target driving mode is a third mode where the power of the engine is transmitted to wheels, and the one of a sound guide, a voice command and a combination thereof is unlikely to be additionally generated.

11. A hybrid electric vehicle (HEV) comprising:
an engine;
a motor; and
a control unit configured to determine whether a first condition for a sound input and output function and a second condition for an internal noise level are satisfied, determine whether operation termination of an engine is possible when the first condition and the second condition are satisfied, control the HEV to be driven in a first mode, in which a starter/generator motor charges a battery with power of the engine, in response to determination that the operation termination of the engine is impossible, and perform noise reduction control by changing an operating point of the engine during the first mode.

12. The HEV of claim 11, wherein the first condition is satisfied when an output of a sound guide is scheduled, an input of a voice command is started, or the output of the sound guide is scheduled and the input of the voice command is started.

13. The HEV of claim 11, wherein the second condition is satisfied when the internal noise level is greater than a preset reference noise level.

14. The HEV of claim 11, wherein the control unit is configured to determine whether the operation termination of the engine is possible based on one of a state of charge (SOC) of the battery, whether an air conditioning request is generated, whether motor discharge is restricted and a combination thereof.

15. The HEV of claim 11, wherein the control unit is configured to control the HEV to be driven in a second mode, in which the vehicle drives without operating the engine, in response to determination the operation termination of the engine is possible.

16. The HEV of claim 11, wherein the control unit is configured to perform the noise reduction control by changing a current operating point of the engine to an operating point having a lower noise level.

17. The HEV of claim 16, wherein the control unit is configured to perform change to an operating point having a lower noise level by referring to a noise level map for torque and revolution per minute (RPM) of the engine.

18. The HEV of claim 11, wherein the control unit is configured to:
determine whether one of a sound guide, a voice command and a combination thereof is likely to be additionally generated; and
terminate the noise reduction control at a preset point in time, in response to determination that the one of a sound guide, a voice command and a combination thereof is unlikely to be additionally generated.

19. The HEV of claim 18, wherein the control unit is configured to determine whether the one of a sound guide, a voice command and a combination thereof is likely to be additionally generated, based on one of content of the sound guide, content of the voice command and a combination thereof.

20. The HEV of claim 18, wherein the control unit is configured to check a target driving mode, and change a current operating point of the engine to an operating point having RPM corresponding to motor RPM, when the target driving mode is a third mode where the power of the engine is transmitted to wheels, and the one of a sound guide, a voice command and a combination thereof is unlikely to be additionally generated.
